(19) United States
(12) Patent Application Publication
(10) Pub. No.: US 2023/0063026 A1
(43) Pub. Date: Mar. 2, 2023

(54) ASPECTS OF WAKE-UP SIGNAL (WUS) TRANSMISSION IN IDLE MODE

(71) Applicant: Telefonaktiebolaget LM Ericsson (publ), Stockholm (SE)

(72) Inventors: Andres REIAL, Höllviken (SE); Ali NADER, Malmö (SE); Sina MALEKI, Malmö (SE)

(21) Appl. No.: 17/799,097

(22) PCT Filed: Feb. 12, 2021
(86) PCT No.: PCT/SE2021/050120

§ 371 Date: Aug. 11, 2022

Related U.S. Application Data
(60) Provisional application No. 62/976,142, filed on Feb. 13, 2020.

(51) Int. Cl. H04W 72/04

(52) U.S. Cl. CPC H04W 72/042

(57) ABSTRACT

A method, system and apparatus are disclosed related to aspects of wake-up signal (WUS) transmission. In one embodiment, a network node is configured to transmit a wake-up signal (WUS), the WUS indicating a presence of a paging physical downlink control channel (PDCCH) in at least one paging occasion; and the WUS being at least one of a 5 physical downlink control channel (PDCCH) signal, a reference signal (RS) a sequence-based signal, a synchronization signal, a secondary synchronization signal (SSS), a primary synchronization signal (PSS), a channel state information reference signal (CSI-RS) and a tracking reference signal (TRS). In one embodiment, a wireless device (WD) configured to monitor for a wake-up signal (WUS), the WUS indicating a presence of a aging physical 0 downlink control channel (PDCCH) in at least one paging occasion.

### TECHNICAL FIELD

The present disclosure relates to wireless communications, and in particular, to aspects of wake-up signal (WUS) transmission.

### INTRODUCTION

Idle/inactive discontinuous reception (DRX), such as in Third Generation Partnership Project (3GPP) networks, is an energy saving mechanism allowing a wireless device (WD), e.g., user equipment (UE), to remain in a deep sleep for a dominant fraction of the time when no data transmission is ongoing. DRX operation by a WD entails paging monitoring and radio resource management (RRM) measurements to determine the appropriate camping cell. A network node configures the WD with a DRX period that determines the paging monitoring rate; typically, RRM measurements are performed at a same rate.

For 3GPP Long Term Evolution-Category M1 (LTE-M) or massive machine-type communication (mMTC) and Narrowband-Internet-of-Things (NB-IoT) devices for which DRX activities are a dominant source of energy consumption, a wake-up signal (WUS) solution for idle mode was specified in 3GPP Release 15 (Rel-15). The approach defined a sequence-based signal design and addressed primarily the use case associated with physical downlink control channel (PDCCH) coverage extension, i.e., paging PDCCH repetition in a paging occasion (PO). The approach may be referred to as mMTC-WUS.

In connected mode, the connected mode DRX (cDRX) framework is used for reducing unnecessary monitoring of scheduling PDCCH, when no new data is available for transmission in Open Systems Interconnection (OSI) Layer 1 (L1). WUS for cDRX specified in 3GPP Release 16 (Rel-16), uses a PDCCH-based WUS design. It may be referred to as connected mode-WUS.

### SUMMARY

Some embodiments advantageously provide methods, systems, and apparatuses for aspects of wake-up signal (WUS) transmission.

In one embodiment, a method implemented in a network node includes transmit a wake-up signal (WUS), the WUS indicating a presence of a paging physical downlink control channel (PDCCH) in at least one paging occasion; and transmitting the PDCCH and/or a physical downlink shared channel (PDSCH) scheduled by the PDCCH.

In one embodiment, a method implemented in a wireless device (WD) includes monitoring for a wake-up signal (WUS), the WUS indicating a presence of a paging physical downlink control channel (PDCCH) in at least one paging occasion.

According to an aspect of the present disclosure, a method implemented in a wireless device, WD, is provided. The method comprises monitoring for a wake-up signal, WUS, in idle mode, the WUS indicating a presence of a paging physical downlink control channel, PDCCH, in at least one paging occasion, PO, and the WUS being at least one of a physical downlink control channel, PDCCH, signal, a reference signal, RS, a sequence-based signal, a synchronization signal, a secondary synchronization signal, SSS, a primary synchronization signal, PSS, a channel state information reference signal, CSI-RS, and a tracking reference signal, TRS; and when the WUS is detected, monitoring the at least one PO for the indicated paging PDCCH.

In some embodiments, the WUS is a downlink control information, DCI, message on the PDCCH. In some embodiments, the WUS is a non-cell-defining synchronization signal block, SSB, transmission at a predetermined time and/or frequency location, the predetermined location being outside of a cell-defining SSB grid and the non-cell-defining SSB transmission comprising the PSS and the SSS. In some embodiments, the non-cell-defining SSB transmission comprising a plurality of SSSs and the monitoring for the WUS comprising monitoring for at least one SSS corresponding to a WUS group to which the WD belongs. In some embodiments, the method comprises receiving a reference signal, RS, before monitoring for the WUS, the monitoring for the WUS being a result of receipt of the RS. In some embodiments, the WUS comprises at least one of: a 0-bit payload; a non-zero size payload; a predetermined downlink control information, DCI, format; a DCI format 2-6; an encoding by a predetermined radio network temporary identifier, RNTI; and WUS group information.

In some embodiments, the idle mode is at least one of a radio resource control, RRC, idle state and a RRC inactive state. In some embodiments, the WUS further comprises a paging group indication associating the WUS to at least one paging group. In some embodiments, the WUS further comprises a group indication, the group indication invoking PDCCH monitoring for multiple groups of WDs. In some embodiments, at least one group of the multiple groups of WDs not being paged. In some embodiments, the WUS comprises a sequence, the sequence indicating to the WD to monitor the at least one PO for the indicated paging PDCCH regardless of the group that the WD belongs to.

In some embodiments, the method further includes receiving a configuration of the WUS, the configuration indicating at least one of a code, a sequence, an offset, a radio network temporary identifier, RNTI, a search space, a downlink control information, DCI, size, a time associated with a validity timer and at least one time and/or frequency resource in which the WUS is to be transmitted. In some embodiments, receiving the configuration of the WUS in at least one of: a system information, SI; a dedicated radio resource control, RRC, when the WD was in a connected mode; and a RRC release message. In some embodiments, the WUS is activated by at least one of: an indicator in at least one of a system information, SI, and a Layer 1, L1, signaling; a paging downlink control information, DCI; and at least one of a presence and an absence of configuration information in the SI.

In some embodiments, the WUS is only valid for a specific amount of time, the specific amount of time being based at least in part on a validity timer. In some embodiments, receiving the WUS extends the validity timer and/or receiving the paging PDCCH stops the validity timer. In some embodiments, the WUS comprises at least one of: a bandwidth equal to or lower than a synchronization signal block, SSB, bandwidth; a quadrature phase shift keying, QPSK, transmission; and a reduced time duration as compared to a time duration associated with a full-power reception operation.

According to an aspect of the present disclosure, a method implemented in a network node is provided. The method comprises transmitting a wake-up signal, WUS, in idle mode the WUS indicating a presence of a paging physical downlink control channel, PDCCH, in at least one paging occasion, PO, and the WUS being at least one of a physical downlink control channel, PDCCH, signal, a reference signal, RS, a sequence-based signal, a synchronization signal, a secondary synchronization signal, SSS, a primary synchronization signal, PSS, a channel state information reference signal, CSI-RS, and a tracking reference signal, TRS; and transmitting the paging PDCCH and/or a physical downlink shared channel, PDSCH, scheduled by the paging PDCCH.

In some embodiments, the WUS is a downlink control information, DCI, message on the PDCCH. In some embodiments, the WUS is a non-cell-defining synchronization signal block, SSB, transmission at a predetermined time and/or frequency location, the predetermined location being outside of a cell-defining SSB grid and the non-cell-defining SSB transmission comprising the PSS and the SSS. In some embodiments, the non-cell-defining SSB transmission comprising a plurality of SSSs and the monitoring for the WUS comprising monitoring for at least one SSS corresponding to a WUS group to which the WD belongs. In some embodiments, the method comprises transmitting a reference signal, RS, before transmitting the WUS, the RS transmission indicating a presence of the WUS.

In some embodiments, the WUS comprises at least one of: a 0-bit payload; a non-zero size payload; a predetermined downlink control information, DCI, format; a DCI format 2-6; an encoding by a predetermined radio network temporary identifier, RNTI; and WUS group information. In some embodiments, the idle mode is at least one of a radio resource control, RRC, idle state and a RRC inactive state. In some embodiments, the WUS further comprises a paging group indication associating the WUS to at least one paging group. In some embodiments, the WUS further comprises a group indication, the group indication invoking PDCCH monitoring for multiple groups of WDs. In some embodiments, at least one group of the multiple groups of WDs not being paged.

In some embodiments, the WUS comprises a sequence, the sequence indicating to a wireless device, WD, to monitor the at least one PO for the indicated paging PDCCH regardless of the group that the WD belongs to. In some embodiments, the method further includes transmitting a configuration of the WUS, the configuration indicating at least one of a code, a sequence, an offset, a radio network temporary identifier, RNTI, a search space, a downlink control information, DCI, size, a time associated with a validity timer and at least one time and/or frequency resource in which the WUS is to be transmitted. In some embodiments, transmitting the configuration of the WUS in at least one of: a system information, SI; a dedicated radio resource control, RRC, when the WD was in a connected mode; and a RRC release message.

In some embodiments, the WUS is activated by at least one of: an indicator in at least one of a system information, SI, and a Layer 1, L1, signaling; a paging downlink control information, DCI; and at least one of a presence and an absence of configuration information in the SI. In some embodiments, the WUS is only valid for a specific amount of time, the specific amount of time being based at least in part on a validity timer. In some embodiments, transmitting the WUS extends the validity timer and/or transmitting the paging PDCCH stops the validity timer. In some embodiments, the WUS comprises at least one of: a bandwidth equal to or lower than a synchronization signal block, SSB, bandwidth; a quadrature phase shift keying, QPSK, transmission; and a reduced time duration as compared to a time duration associated with a full-power reception operation.

According to an aspect of the present disclosure, a wireless device, WD, configured to communicate with a network node is provided. The WD comprises processing circuitry. The processing circuitry is configured to cause the WD to monitor for a wake-up signal, WUS, in idle mode, the WUS indicating a presence of a paging physical downlink control channel, PDCCH, in at least one paging occasion, PO, and the WUS being at least one of a physical downlink control channel, PDCCH, signal, a reference signal, RS, a sequence-based signal, a synchronization signal, a secondary synchronization signal, SSS, a primary synchronization signal, PSS, a channel state information reference signal, CSI-RS, and a tracking reference signal, TRS; and when the WUS is detected, monitor the at least one PO for the indicated paging PDCCH.

In some embodiments, the WUS is a downlink control information, DCI, message on the PDCCH. In some embodiments, the WUS is a non-cell-defining synchronization signal block, SSB, transmission at a predetermined time and/or frequency location, the predetermined location being outside of a cell-defining SSB grid and the non-cell-defining SSB transmission comprising the PSS and the SSS. In some embodiments, the non-cell-defining SSB transmission comprising a plurality of SSSs and the monitoring for the WUS comprising monitoring for at least one SSS corresponding to a WUS group to which the WD belongs. In some embodiments, the method comprises receiving a reference signal, RS, before monitoring for the WUS, the monitoring for the WUS being a result of receipt of the RS. In some embodiments, the WUS comprises at least one of: a 0-bit payload; a non-zero size payload; a predetermined downlink control information, DCI, format; a DCI format 2-6; an encoding by a predetermined radio network temporary identifier, RNTI; and WUS group information.

In some embodiments, the idle mode is at least one of a radio resource control, RRC, idle state and a RRC inactive state. In some embodiments, the WUS further comprises a paging group indication associating the WUS to at least one paging group. In some embodiments, the WUS further comprises a group indication, the group indication invoking PDCCH monitoring for multiple groups of WDs. In some embodiments, at least one group of the multiple groups of WDs not being paged. In some embodiments, the WUS comprises a sequence, the sequence indicating to the WD to monitor the at least one PO for the indicated paging PDCCH regardless of the group that the WD belongs to. In some embodiments, the method further includes receiving a configuration of the WUS, the configuration indicating at least one of a code, a sequence, an offset, a radio network temporary identifier, RNTI, a search space, a downlink control information, DCI, size, a time associated with a validity timer and at least one time and/or frequency resource in which the WUS is to be transmitted.

In some embodiments, receiving the configuration of the WUS in at least one of: a system information, SI; a dedicated radio resource control, RRC, when the WD was in a connected mode; and a RRC release message. In some embodiments, the WUS is activated by at least one of: an indicator in at least one of a system information, SI, and a Layer 1, L1, signaling; a paging downlink control information, DCI; and at least one of a presence and an absence of configuration information in the SI. In some embodiments, the WUS is only valid for a specific amount of time, the specific amount of time being based at least in part on a validity timer. In some embodiments, receiving the WUS extends the validity timer and/or receiving the paging PDCCH stops the validity timer. In some embodiments, the WUS comprises at least one of: a bandwidth equal to or lower than a synchronization signal block, SSB, bandwidth; a quadrature phase shift keying, QPSK, transmission; and a reduced time duration as compared to a time duration associated with a full-power reception operation.

According to an aspect of the present disclosure, a network node configured to communicate with a wireless device, WD, is provided. The network node comprises processing circuitry. The processing circuitry is configured to cause the network node to transmit a wake-up signal, WUS, in idle mode the WUS indicating a presence of a paging physical downlink control channel, PDCCH, in at least one paging occasion, PO, and the WUS being at least one of a physical downlink control channel, PDCCH, signal, a reference signal, RS, a sequence-based signal, a synchronization signal, a secondary synchronization signal, SSS, a primary synchronization signal, PSS, a channel state information reference signal, CSI-RS, and a tracking reference signal, TRS; and transmit the paging PDCCH and/or a physical downlink shared channel, PDSCH, scheduled by the paging PDCCH.

In some embodiments, the WUS is a downlink control information, DCI, message on the PDCCH. In some embodiments, the WUS is a non-cell-defining synchronization signal block, SSB, transmission at a predetermined time and/or frequency location, the predetermined location being outside of a cell-defining SSB grid and the non-cell-defining SSB transmission comprising the PSS and the SSS. In some embodiments, the non-cell-defining SSB transmission comprising a plurality of SSSs and the monitoring for the WUS comprising monitoring for at least one SSS corresponding to a WUS group to which the WD belongs. In some embodiments, the processing circuitry is configured to cause the network node to transmit a reference signal, RS, before transmitting the WUS, the RS transmission indicating a presence of the WUS. In some embodiments, the WUS comprises at least one of: a 0-bit payload; a non-zero size payload; a predetermined downlink control information, DCI, format; a DCI format 2-6; an encoding by a predetermined radio network temporary identifier, RNTI; and WUS group information.

In some embodiments, the idle mode is at least one of a radio resource control, RRC, idle state and a RRC inactive state. In some embodiments, the WUS further comprises a paging group indication associating the WUS to at least one paging group. In some embodiments, the WUS further comprises a group indication, the group indication invoking PDCCH monitoring for multiple groups of WDs. In some embodiments, at least one group of the multiple groups of WDs not being paged. In some embodiments, the WUS comprises a sequence, the sequence indicating to a wireless device, WD, to monitor the at least one PO for the indicated paging PDCCH regardless of the group that the WD belongs to. In some embodiments, the processing circuitry is further configured to cause the network node to transmit a configuration of the WUS, the configuration indicating at least one of a code, a sequence, an offset, a radio network temporary identifier, RNTI, a search space, a downlink control information, DCI, size, a time associated with a validity timer and at least one time and/or frequency resource in which the WUS is to be transmitted.

In some embodiments, the processing circuitry is configured to cause the network node to transmit the configuration of the WUS in at least one of: a system information, SI; a dedicated radio resource control, RRC, when the WD was in a connected mode; and a RRC release message. In some embodiments, the WUS is activated by at least one of: an indicator in at least one of a system information, SI, and a Layer 1, L1, signaling; a paging downlink control information, DCI; and at least one of a presence and an absence of configuration information in the SI. In some embodiments, the WUS is only valid for a specific amount of time, the specific amount of time being based at least in part on a validity timer. In some embodiments, transmitting the WUS extends the validity timer and/or transmitting the paging PDCCH stops the validity timer. In some embodiments, the WUS comprises at least one of: a bandwidth equal to or lower than a synchronization signal block, SSB, bandwidth; a quadrature phase shift keying, QPSK, transmission; and a reduced time duration as compared to a time duration associated with a full-power reception operation.

In some embodiments, an apparatus comprising computer program instructions executable by at least one processor to perform any one or more of the methods above is provided.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an exemplary network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating exemplary methods implemented in a communication system including a host computer, a network node and a wireless device for executing a client application at a wireless device according to some embodiments of the present disclosure;

FIG. 4 is a flowchart illustrating exemplary methods implemented in a communication system including a host computer, a network node and a wireless device for receiving user data at a wireless device according to some embodiments of the present disclosure;

FIG. 5 is a flowchart illustrating exemplary methods implemented in a communication system including a host computer, a network node and a wireless device for receiving user data from the wireless device at a host computer according to some embodiments of the present disclosure;

FIG. 6 is a flowchart illustrating exemplary methods implemented in a communication system including a host computer, a network node and a wireless device for receiving user data at a host computer according to some embodiments of the present disclosure;

FIG. 7 is a flowchart of an exemplary process in a network node for WUS unit according to some embodiments of the present disclosure;

FIG. 8 is a flowchart of an exemplary process in a wireless device for monitoring unit according to some embodiments of the present disclosure;

FIG. 9 is a flowchart of an exemplary process in a network node according to some embodiments of the present disclosure;

FIG. 10 is a flowchart of an exemplary process in a wireless device according to some embodiments of the present disclosure;

FIG. 11 is a flowchart of another exemplary process in a network node according to some embodiments of the present disclosure;

FIG. 12 is a flowchart of another exemplary process in a wireless device according to some embodiments of the present disclosure;

FIG. 13 is a flowchart of an exemplary process of a unified idle mode solution according to some embodiments of the present disclosure;

FIG. 14 illustrates an example timeline of signal transmission and WD UE activity according to some embodiments of the present disclosure; and

FIG. 15 is an example timeline for signal transmissions and WD processing according to some embodiments of the present disclosure.

### DETAILED DESCRIPTION

The 3GPP has specified two WUS frameworks—for enhanced Mobile Broadband (eMBB) connected mode and for mMTC/IoT idle mode. These solutions address certain extremes in terms of PDCCH monitoring frequency and energy cost. The connected-mode WUS addresses relatively frequent (e.g., 80-160 millisecond (ms) period) onDurations and aims at shortening the effective PDCCH monitoring window at each monitoring occasion, from 8-10 ms to <1 ms. The mMTC-WUS primarily addresses the issue that the paging PDCCH is repeated for coverage extension, resulting in a very long monitoring window; therefore, the WUS also effectively replaces a long PDCCH monitoring with a short WUS monitoring at each DRX period (up to multiple hours). In both those cases, the overhead due to RRM measurements in conjunction with PDCCH or WUS monitoring is not generally a strong concern.

In some non-mMTC scenarios, the paging PDCCH is not extended but constitutes only 1-2 PDCCH symbols, already well below 1 ms. Therefore, the existing approaches that focus on shortening the paging indication reception may not offer WD power savings (PS) opportunities. Furthermore, performing RRM measurements in conjunction with DRX wake-ups may further reduce WD PS gains from paging procedure modifications. There is thus an opportunity for an improved WUS solution for non-coverage expanded scenarios in idle.

In other scenarios, the network node may configure paging without x-slot scheduling, leading the WD to sample and buffer both the paging PDCCH symbols and the possible following PDSCH symbol positions to avoid data loss during the PDCCH decoding duration. This leads to a longer effective radio frequency (RF) on-time duration during each PO for the WD, and increased WD energy consumption.

In part one below, the present disclosure describes an idle mode DRX solution for use cases without paging coverage extension (e.g., repetitions), targeting a low-power (LP)-receiver (LPR) WD implementation. If no paging is detected, the full WD receiver remains in deep sleep (e.g., ˜8 mW) and both paging WUS (wake-up signal) monitoring and RRM measurements on a synchronization signal block (SSB) are performed using the LPR (e.g., <1 mW). A WUS may be transmitted by the network node to indicate an imminent paging PDCCH and when the WD detects the paging PDCCH using its LPR, the WD activates the full/primary receiver (e.g., primary receiver(s) have more power than the low-power receiver) for monitoring the paging PO and a possible associated PDSCH. The WD may perform low-rate RRM calibration of its LPR using the full receiver (FR).

One or more of the following aspects of WUS transmission (network node) and monitoring (WD) for idle mode in conventional use cases may be included in some embodiments of the present disclosure: WUS signal design for sequence detection suitable for LPR reception, WD LPR operation for that reception, paging group indication in WUS, WUS-PO-SSB offset selection, DRX densification for low paging latency, and other aspects of unified idle mode operation.

In part two below, some embodiments of the present disclosure describe an idle mode WUS approach where a short-duration WUS indicates the presence of a paging PDCCH in one or more of the next POs, obviating WD extended signal monitoring to capture the PDCCH samples and PDSCH samples during PDCCH decoding. The WUS may be a PDCCH or a reference signal (RS), e.g., channel state information-reference signal (CSI-RS) or tracking reference signal (TRS) or similar (sequence-based WUS). The WUS may include grouping information to trigger paging monitoring for only a subset of WDs. The WUS, e.g., a RS, may be used for RRM measurements and additional RS(s) may be provided in the proximity of the WUS for automatic gain control (AGC) and/or time/frequency (T/F) synchronization (T/F sync).

Some embodiments of a WUS approach and a unified WD idle mode processing solution may allow for idle mode energy consumption to be negligible compared to baseline deep sleep mode energy. Some embodiments may provide that WD idle mode energy consumption may be minimized, standby time may be improved and in scenarios network node configurations where false paging results may be limited. Overall WD energy consumption may also be improved in use cases where e.g., idle mode dominates over connected mode, e.g., infrequent and small data transmissions.

Before describing in detail exemplary embodiments, it is noted that the embodiments reside primarily in combinations of apparatus components and processing steps related to aspects of wake-up signal (WUS) transmission. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Even though the descriptions herein may be explained in the context of one of a Downlink (DL) and an Uplink (UL) communication, it should be understood that the basic principles disclosed may also be applicable to the other of the one of the DL and the UL communication. In some embodiments in this disclosure, the principles may be considered applicable to a transmitter and a receiver. For DL communication, the network node is the transmitter and the receiver is the WD. For the UL communication, the transmitter is the WD and the receiver is the network node.

Although the description herein may be explained in the context of idle mode DRX, it should be understood that the principles may also be applicable to other WD operational modes.

In some embodiments of the present disclosure, the term “idle” as used herein may refer to both RRC_IDLE and RRC_INACTIVE modes. In some embodiments, the phrase “connected mode” as used herein may refer to RRC connected mode.

Any two or more embodiments described in this disclosure may be combined in any way with each other.

The term “resource”, as used herein, is intended to be interpreted in a general way. It may indicate an arbitrary combination of subcarriers, time slots, codes and spatial dimensions.

The term “signaling” used herein may comprise any of: high-layer signaling (e.g., via Radio Resource Control (RRC) or a like), lower-layer signaling (e.g., via a physical control channel or a broadcast channel), or a combination thereof. The signaling may be implicit or explicit. The signaling may further be unicast, multicast or broadcast. The signaling may also be directly to another node or via a third node.

The term “radio measurement” used herein may refer to any measurement performed on radio signals. Radio measurements can be absolute or relative. Radio measurement may be called as signal level which may be signal quality and/or signal strength. Radio measurements can be e.g., intra-frequency, inter-frequency, inter-RAT measurements, CA measurements, etc. Radio measurements can be unidirectional (e.g., DL or UL) or bidirectional (e.g., Round Trip Time (RTT), Receive-Transmit (Rx-Tx), etc.). Some examples of radio measurements: timing measurements (e.g., Time of Arrival (TOA), timing advance, RTT, Reference Signal Time Difference (RSTD), Rx-Tx, propagation delay, etc.), angle measurements (e.g., angle of arrival), power-based measurements (e.g., received signal power, Reference Signals Received Power (RSRP), received signal quality, Reference Signals Received Quality (RSRQ), Signal-to-interference-plus-noise Ratio (SINR), Signal Noise Ratio (SNR), interference power, total interference plus noise, Received Signal Strength Indicator (RSSI), noise power, etc.), cell detection or cell identification, radio link monitoring (RLM), system information (SI) reading, etc. The inter-frequency and inter-RAT measurements are carried out by the WD in measurement gaps unless the WD is capable of doing such measurement without gaps. Examples of measurement gaps are measurement gap id #0 (each gap of 6 ms occurring every 40 ms), measurement gap id #1 (each gap of 6 ms occurring every 80 ms), etc. The measurement gaps are configured at the WD by the network node.

Generally, it may be considered that the network, e.g., a signaling radio node and/or node arrangement (e.g., network node), configures a WD, in particular with the transmission resources. A resource may in general be configured with one or more messages. Different resources may be configured with different messages, and/or with messages on different layers or layer combinations. The size of a resource may be represented in symbols and/or subcarriers and/or resource elements and/or physical resource blocks (depending on domain), and/or in number of bits it may carry, e.g., information or payload bits, or total number of bits. The set of resources, and/or the resources of the sets, may pertain to the same carrier and/or bandwidth part, and/or may be located in the same slot, or in neighboring slots.

In some embodiments, control information on one or more resources may be considered to be transmitted in a message having a specific format. A message may comprise or represent bits representing payload information and coding bits, e.g., for error coding.

Receiving (or obtaining) information may comprise receiving one or more information messages (e.g., an RRC configuration parameter, WUS, PDCCH, reference signals, etc.) via signaling. It may be considered that receiving signaling/transmissions comprises demodulating and/or decoding and/or detecting, e.g., blind detection of, one or more messages, in particular a message carried by the signaling, e.g., based on an assumed set of resources, which may be searched and/or monitored and/or listened for the information. It may be assumed that both sides of the communication are aware of the configurations, and may determine the set of resources, e.g., based on the reference size.

Signaling may generally comprise one or more symbols and/or signals and/or messages. A signal may comprise or represent one or more bits. An indication may represent signaling, and/or be implemented as a signal, or as a plurality of signals. One or more signals may be included in and/or represented by a message. Signaling, in particular control signaling, may comprise a plurality of signals and/or messages, which may be transmitted on different carriers and/or be associated to different signaling processes, e.g., representing and/or pertaining to one or more such processes and/or corresponding information. An indication may comprise signaling, and/or a plurality of signals and/or messages and/or may be comprised therein, which may be transmitted on different carriers and/or be associated to different acknowledgement signaling processes, e.g., representing and/or pertaining to one or more such processes. Signaling associated to a channel may be transmitted such that represents signaling and/or information for that channel, and/or that the signaling is interpreted by the transmitter and/or receiver to belong to that channel. Such signaling may generally comply with transmission parameters and/or format/s for the channel.

An indication (e.g., an indication of a paging PDCCH, etc.) generally may explicitly and/or implicitly indicate the information it represents and/or indicates. Implicit indication may for example be based on position and/or resource used for transmission. Explicit indication may for example be based on a parametrization with one or more parameters, and/or one or more index or indices corresponding to a table, and/or one or more bit patterns representing the information.

Configuring a radio node, in particular a terminal or WD (e.g., WD), may refer to the radio node being adapted or caused or set and/or instructed to operate according to the configuration (e.g., to monitor an x-RNTI or a binary sequence for C-RNTI to determine which table to be used to interpret an indication or signal). Configuring may be done by another device, e.g., a network node (e.g., network node) (for example, a base station or gNB) or network, in which case it may comprise transmitting configuration data to the radio node to be configured. Such configuration data may represent the configuration to be configured and/or comprise one or more instruction pertaining to a configuration, e.g., a configuration for transmitting and/or receiving on allocated resources, in particular frequency resources. A radio node may configure itself, e.g., based on configuration data received from a network or network node. A network node may utilize, and/or be adapted to utilize, its circuitry/ies for configuring. Allocation information may be considered a form of configuration data. Configuration data may comprise and/or be represented by configuration information, and/or one or more corresponding indications and/or message/s (e.g., WUS).

A channel may generally be a logical or physical channel. A channel may comprise and/or be arranged on one or more carriers, in particular a plurality of subcarriers. A wireless communication network may comprise at least one network node, in particular a network node as described herein. A terminal connected or communicating with a network may be considered to be connected or communicating with at least one network node, in particular any one of the network nodes described herein.

Transmitting in downlink may pertain to transmission from the network or network node to the terminal. The terminal may be considered the WD or UE. Transmitting in uplink may pertain to transmission from the terminal to the network or network node. Transmitting in sidelink may pertain to (direct) transmission from one terminal to another. Uplink, downlink and sidelink (e.g., sidelink transmission and reception) may be considered communication directions. In some variants, uplink and downlink may also be used to described wireless communication between network nodes, e.g., for wireless backhaul and/or relay communication and/or (wireless) network communication for example between base stations or similar network nodes, in particular communication terminating at such. It may be considered that backhaul and/or relay communication and/or network communication is implemented as a form of sidelink or uplink communication or similar thereto.

Configuring a Radio Node

Configuring a radio node, in particular a terminal or user equipment or the WD, may refer to the radio node being adapted or caused or set and/or instructed to operate according to the configuration (e.g., WUS configuration). Configuring may be done by another device, e.g., a network node (for example, a radio node of the network like a base station or eNodeB) or network, in which case it may comprise transmitting configuration data to the radio node to be configured. Such configuration data may represent the configuration to be configured and/or comprise one or more instruction pertaining to a configuration, e.g., a configuration for transmitting and/or receiving on allocated resources, in particular frequency resources, or e.g., configuration for performing certain measurements on certain subframes or radio resources. A radio node may configure itself, e.g., based on configuration data received from a network or network node. A network node may use, and/or be adapted to use, its circuitry/ies for configuring. Allocation information may be considered a form of configuration data. Configuration data may comprise and/or be represented by configuration information, and/or one or more corresponding indications and/or message/s.

Configuring in General

Generally, configuring may include determining configuration data representing the configuration and providing, e.g., transmitting, it to one or more other nodes (parallel and/or sequentially), which may transmit it further to the radio node (or another node, which may be repeated until it reaches the wireless device). Alternatively, or additionally, configuring a radio node, e.g., by a network node or other device, may include receiving configuration data and/or data pertaining to configuration data, e.g., from another node like a network node, which may be a higher-level node of the network, and/or transmitting received configuration data to the radio node. Accordingly, determining a configuration and transmitting the configuration data to the radio node may be performed by different network nodes or entities, which may be able to communicate via a suitable interface, e.g., an X2 interface in the case of LTE or a corresponding interface for NR. Configuring a terminal (e.g., WD) may comprise scheduling downlink and/or uplink transmissions for the terminal, e.g., downlink data and/or downlink control signaling and/or DCI and/or uplink control or data or communication signaling, in particular acknowledgement signaling, and/or configuring resources (e.g., WUS resources) and/or a resource pool therefor. In particular, configuring a terminal (e.g., WD) may comprise configuring the WD to perform certain measurements on certain subframes or radio resources and reporting such measurements according to embodiments of the present disclosure.

A resource element may represent a smallest time-frequency resource, e.g., representing the time and frequency range covered by one symbol or a number of bits represented in a common modulation. A resource element may e.g., cover a symbol time length and a subcarrier, in particular in 3GPP standards. A data transmission may represent and/or pertain to transmission of specific data, e.g., a specific block of data and/or transport block.

In some embodiments, the term “resource” is intended to indicate a frequency resource, and/or a time resource.

In some embodiments, the term communication direction is intended to indicate an UL communication direct (i.e., communications from the WD to the network node) and/or a DL communication direction (i.e., communications in a direction from the network node to the WD).

The term time resource used herein may correspond to any type of physical resource or radio resource expressed in terms of length of time. Examples of time resources are: symbol, time slot, subframe, radio frame, TTI, interleaving time, etc. As used herein, in some embodiments, the terms “subframe,” “slot,” subframe/slot” and “time resource” are used interchangeably and are intended to indicate a time resource and/or a time resource number.

A cell may be generally a communication cell, e.g., of a cellular or mobile communication network, provided by a node. A serving cell may be a cell on or via which a network node (the node providing or associated to the cell, e.g., base station or eNodeB) transmits and/or may transmit data (which may be data other than broadcast data) to a user equipment, in particular control and/or user or payload data, and/or via or on which a user equipment transmits and/or may transmit data to the node; a serving cell may be a cell for or on which the user equipment is configured and/or to which it is synchronized and/or has performed an access procedure, e.g., a random access procedure, and/or in relation to which it is in a RRC_connected or RRC_idle state, e.g., in case the node and/or user equipment and/or network follow the LTE or 3GPP New Radio-standard. One or more carriers (e.g., uplink and/or downlink carrier/s and/or a carrier for both uplink and downlink) may be associated to a cell.

It may be considered for cellular communication there is provided at least one uplink (UL) connection and/or channel and/or carrier and at least one downlink (DL) connection and/or channel and/or carrier, e.g., via and/or defining a cell, which may be provided by a network node, in particular a base station or eNodeB. An uplink direction may refer to a data transfer direction from a terminal to a network node, e.g., base station and/or relay station. A downlink direction may refer to a data transfer direction from a network node, e.g., base station and/or relay node, to a terminal. UL and DL may be associated to different frequency resources, e.g., carriers and/or spectral bands. A cell may comprise at least one uplink carrier and at least one downlink carrier, which may have different frequency bands. A network node, e.g., a base station or eNodeB, may be adapted to provide and/or define and/or control one or more cells, e.g., a PCell and/or a LA cell.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide aspects of wake-up signal (WUS) transmission.

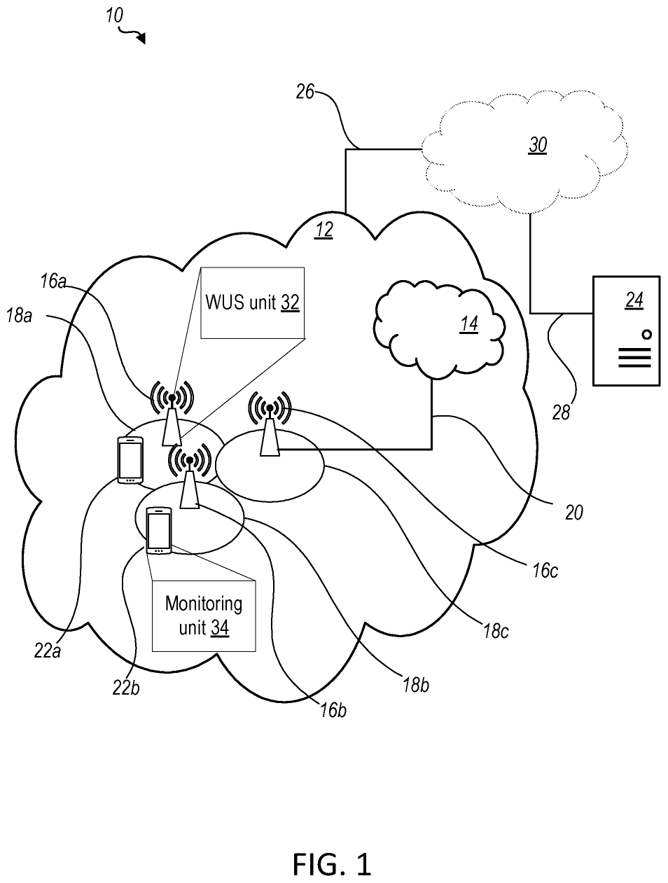

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a WUS unit 32 which is configured to transmit a wake-up signal (WUS), the WUS indicating a presence of a paging physical downlink control channel (PDCCH) in at least one paging occasion, the WUS being at least one of a physical downlink control channel (PDCCH) signal, a reference signal (RS) a sequence-based signal, a synchronization signal, a secondary synchronization signal (SSS), a primary synchronization signal (PSS), a channel state information reference signal (CSI-RS) and a tracking reference signal (TRS); and/or transmit the PDCCH and/or a physical downlink shared channel (PDSCH) scheduled by the PDCCH.

A wireless device 22 is configured to include a monitoring unit 34 which is configured to monitor for a wake-up signal (WUS), the WUS indicating a presence of a paging physical downlink control channel (PDCCH) in at least one paging occasion, the WUS being at least one of a physical downlink control channel (PDCCH) signal, a reference signal (RS) a sequence-based signal, a synchronization signal, a secondary synchronization signal (SSS), a primary synchronization signal (PSS), a channel state information reference signal (CSI-RS) and a tracking reference signal (TRS).

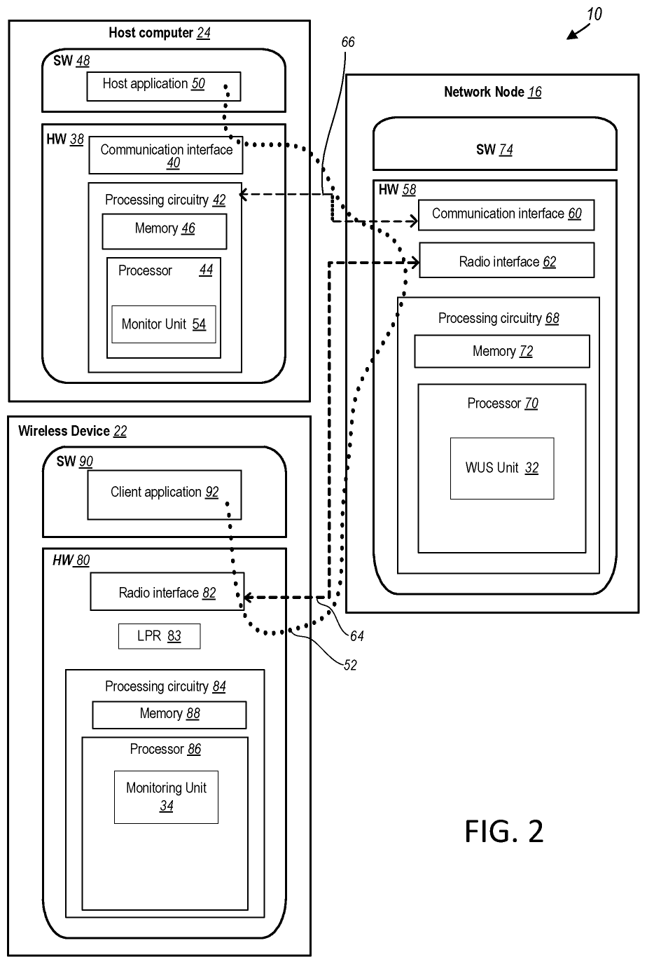

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and/or the wireless device 22. The processing circuitry 42 of the host computer 24 may include a monitor unit 54 configured to enable the service provider to observe, monitor, control, transmit to and/or receive from the network node 16 and/or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

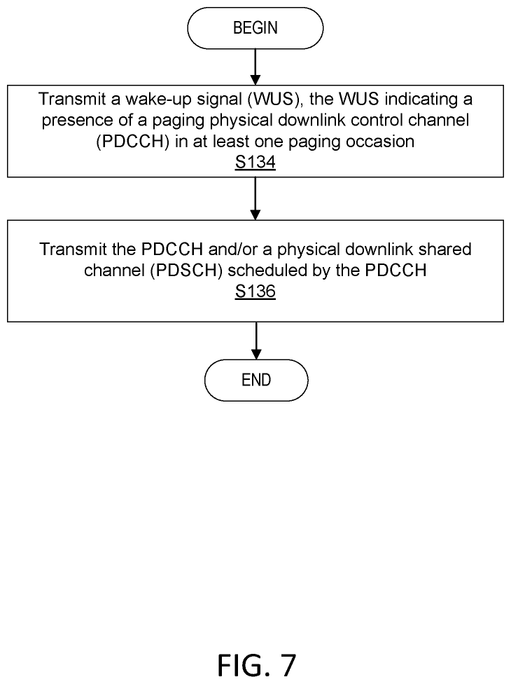

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include WUS unit 32 configured to perform network node methods discussed herein, such as the methods discussed with reference to FIG. 7 as well as other figures.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

In some embodiments, in addition to the radio interface 82, which may include a full receiver, the WD 22 may include a low power receiver 83, that may be used to implement some embodiments of the present disclosure. The full receiver may have more power than the low power receiver 83. In some embodiments, the radio interface 82 may include a lower power receiver 83.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

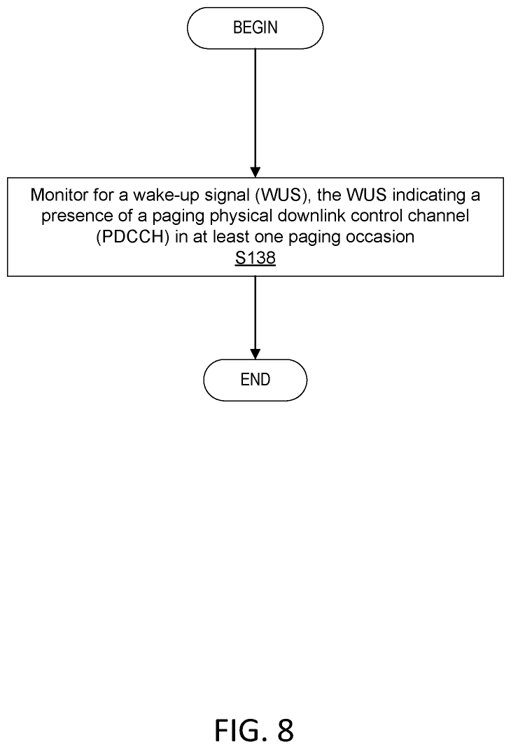

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a monitoring unit 34 configured to perform WD methods discussed herein, such as the methods discussed with reference to FIG. 8 as well as other figures.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing, etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as WUS unit 32, and monitoring unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

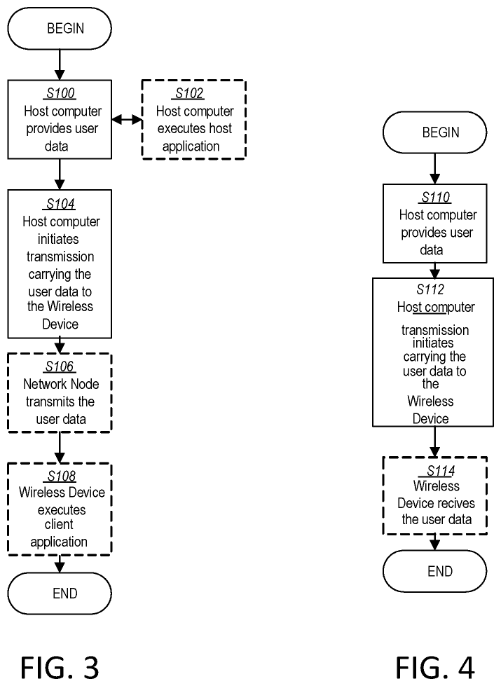

FIG. 3 is a flowchart illustrating an exemplary method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

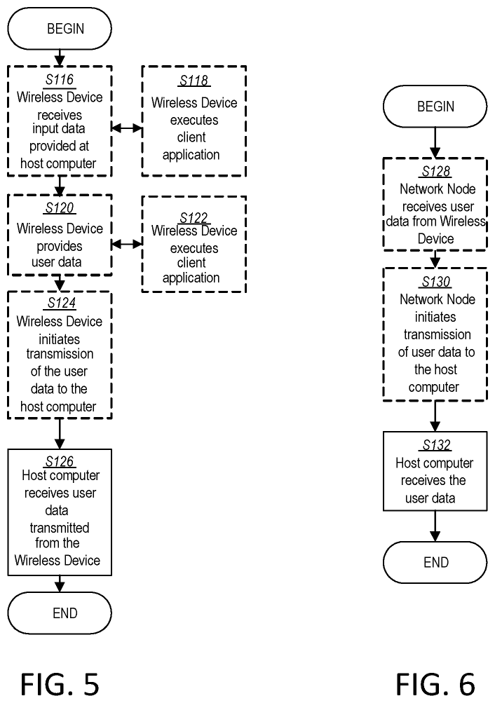

FIG. 5 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

FIG. 7 is a flowchart of an exemplary process in a network node 16 for wake-up signal aspects according to some embodiments of the present disclosure. One or more Blocks and/or functions and/or methods performed by the network node 16 may be performed by one or more elements of network node 16 such as by WUS unit 32 in processing circuitry 68, processor 70, communication interface 60, radio interface 62, etc. according to the example method. The example method includes transmitting (Block S134), such as via WUS unit 32, processing circuitry 68, communication interface 60, processor 70 and/or radio interface 62, a wake-up signal (WUS), the WUS indicating a presence of a paging physical downlink control channel (PDCCH) in at least one paging occasion. The method includes transmitting (Block S136), such as via WUS unit 32, processing circuitry 68, communication interface 60, processor 70 and/or radio interface 62, the PDCCH and/or a physical downlink shared channel (PDSCH) scheduled by the PDCCH.

In some embodiments, transmitting the WUS includes transmitting the WUS to be detectable by a low power receiver (LPR); and transmitting the PDCCH and/or the PDSCH includes transmitting the PDCCH and/or the PDSCH to be detectable by a primary WD receiver, the LPR being different from the primary receiver. In some embodiments, the LPR is a lower power receiver as compared to the primary receiver. In some embodiments, transmitting further comprises transmitting, such as via WUS unit 32, processing circuitry 68, communication interface 60, processor 70 and/or radio interface 62, the WUS to the WD in idle mode discontinuous reception (DRX). In some embodiments, the WUS: is at least one of a physical downlink control channel (PDCCH), a sequence-based signal, a reference signal, a synchronization signal, a channel state information reference signal (CSI-RS) and a tracking reference signal. In some embodiments, the WUS includes a payload and/or group information.

In some embodiments, the method includes transmitting, such as via WUS unit 32, processing circuitry 68, communication interface 60, processor 70 and/or radio interface 62, a configuration of the WUS, the configuration indicating at least one of a code, a sequence, an offset, a search space and at least one time/frequency resource in which the WUS is to be transmitted.

FIG. 8 is a flowchart of an exemplary process in a wireless device 22 for wake-up signal aspects according to some embodiments of the present disclosure. One or more Blocks and/or functions and/or methods performed by WD 22 may be performed by one or more elements of WD 22 such as by monitoring unit 34 in processing circuitry 84, processor 86, radio interface 82, etc. The example method includes monitoring (Block S138), such as via monitoring unit 34, processing circuitry 84, processor 86 and/or radio interface 82, for a wake-up signal (WUS), the WUS indicating a presence of a paging physical downlink control channel (PDCCH) in at least one paging occasion.

In some embodiments, monitoring includes monitoring, via a lower power receiver (LPR), for the WUS: when the WUS is not detected by the LPR 83, continuing, such as via monitoring unit 34, processing circuitry 84, processor 86 and/or radio interface 82, to use the LPR 83 for WUS monitoring; and when the WUS is detected by the LPR 83, activating, such as via monitoring unit 34, processing circuitry 84, processor 86 and/or radio interface 82, a primary receiver, e.g., in the radio interface 82, to monitor the at least one paging occasion for the indicated paging PDCCH and/or receiving a physical downlink shared channel (PDSCH) scheduled by the PDCCH, the LPR 83 being different from the primary receiver in the radio interface 82.

In some embodiments, the LPR 83 is a lower power receiver as compared to the primary receiver in the radio interface 82. In some embodiments, monitoring further includes the WD 22 monitoring, such as via monitoring unit 34, processing circuitry 84, processor 86 and/or radio interface 82, for the WUS in idle mode discontinuous reception (DRX). In some embodiments, the WUS is at least one of a physical downlink control channel (PDCCH), a sequence-based signal, a reference signal, a synchronization signal, a channel state information reference signal (CSI-RS) and a tracking reference signal. In some embodiments, the WUS includes a payload and/or group information.

In some embodiments, the method includes receiving, such as via monitoring unit 34, processing circuitry 84, processor 86 and/or radio interface 82, a configuration of the WUS, the configuration indicating at least one of a code, a sequence, an offset, a search space and at least one time/frequency resource in which the WUS is to be transmitted.

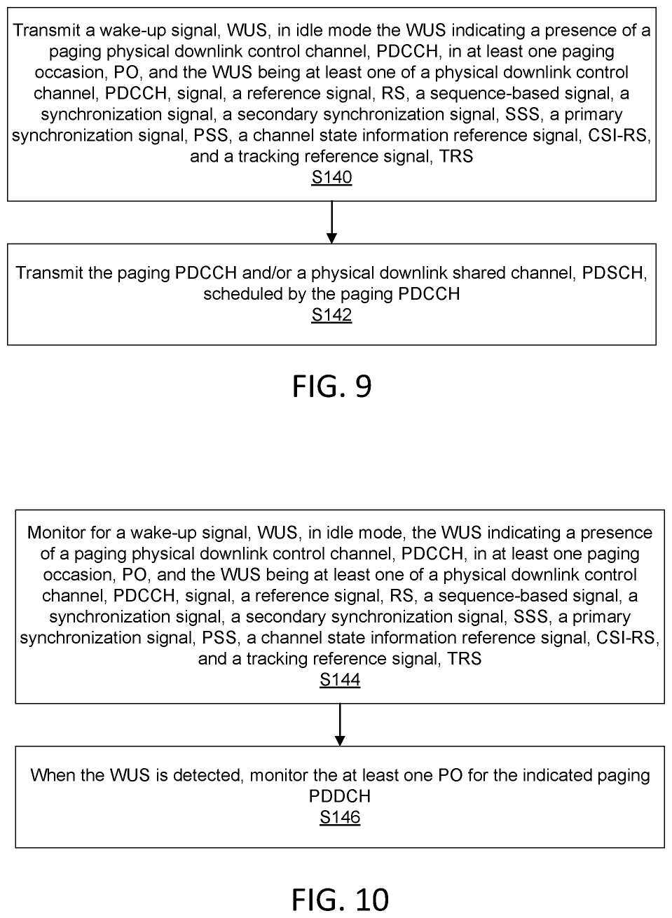

FIG. 9 is a flowchart of an exemplary process in a network node 16 for wake-up signal aspects according to some embodiments of the present disclosure. One or more Blocks and/or functions and/or methods performed by the network node 16 may be performed by one or more elements of network node 16 such as by WUS unit 32 in processing circuitry 68, processor 70, communication interface 60, radio interface 62, etc. according to the example method. The example method includes transmitting (Block S140), such as via WUS unit 32, processing circuitry 68, processor 70, communication interface 60 and/or radio interface 62, a wake-up signal, WUS, in idle mode the WUS indicating a presence of a paging physical downlink control channel, PDCCH, in at least one paging occasion, PO, and the WUS being at least one of a physical downlink control channel, PDCCH, signal, a reference signal, RS, a sequence-based signal, a synchronization signal, a secondary synchronization signal, SSS, a primary synchronization signal, PSS, a channel state information reference signal, CSI-RS, and a tracking reference signal, TRS. The method include transmitting (Block S142), such as via WUS unit 32, processing circuitry 68, processor 70, communication interface 60 and/or radio interface 62, the paging PDCCH and/or a physical downlink shared channel, PDSCH, scheduled by the paging PDCCH.

In some embodiments, the WUS is a downlink control information, DCI, message on the PDCCH. In some embodiments, the WUS is a non-cell-defining synchronization signal block, SSB, transmission at a predetermined time and/or frequency location, the predetermined location being outside of a cell-defining SSB grid and the non-cell-defining SSB transmission comprising the PSS and the SSS. In some embodiments, the non-cell-defining SSB transmission comprising a plurality of SSSs and the monitoring for the WUS comprising monitoring for at least one SSS corresponding to a WUS group to which the WD belongs.

In some embodiments, the method comprises transmitting, such as via WUS unit 32, processing circuitry 68, processor 70, communication interface 60 and/or radio interface 62, a reference signal, RS, before transmitting the WUS, the RS transmission indicating a presence of the WUS. In some embodiments, the WUS comprises at least one of: a 0-bit payload; a non-zero size payload; a predetermined downlink control information, DCI, format; a DCI format 2-6; an encoding by a predetermined radio network temporary identifier, RNTI; and WUS group information. In some embodiments, the idle mode is at least one of a radio resource control, RRC, idle state and a RRC inactive state. In some embodiments, the WUS further comprises a paging group indication associating the WUS to at least one paging group. In some embodiments, the WUS further comprises a group indication, the group indication invoking PDCCH monitoring for multiple groups of WDs. In some embodiments, at least one group of the multiple groups of WDs not being paged.

In some embodiments, the WUS comprises a sequence, the sequence indicating to a wireless device, WD, to monitor the at least one PO for the indicated paging PDCCH regardless of the group that the WD belongs to. In some embodiments, the method further includes transmitting, such as via WUS unit 32, processing circuitry 68, processor 70, communication interface 60 and/or radio interface 62, a configuration of the WUS, the configuration indicating at least one of a code, a sequence, an offset, a radio network temporary identifier, RNTI, a search space, a downlink control information, DCI, size, a time associated with a validity timer and at least one time and/or frequency resource in which the WUS is to be transmitted. In some embodiments, transmitting the configuration of the WUS in at least one of: a system information, SI; a dedicated radio resource control, RRC, when the WD was in a connected mode; and a RRC release message.

In some embodiments, the WUS is activated by at least one of: an indicator in at least one of a system information, SI, and a Layer 1, L1, signaling; a paging downlink control information, DCI; and at least one of a presence and an absence of configuration information in the SI. In some embodiments, the WUS is only valid for a specific amount of time, the specific amount of time being based at least in part on a validity timer. In some embodiments, transmitting the WUS extends the validity timer and/or transmitting the paging PDCCH stops the validity timer. In some embodiments, the WUS comprises at least one of: a bandwidth equal to or lower than a synchronization signal block, SSB, bandwidth; a quadrature phase shift keying, QPSK, transmission; and a reduced time duration as compared to a time duration associated with a full-power reception operation.

FIG. 10 is a flowchart of an exemplary process in a wireless device 22 for wake-up signal aspects according to some embodiments of the present disclosure. One or more Blocks and/or functions and/or methods performed by WD 22 may be performed by one or more elements of WD 22 such as by monitoring unit 34 in processing circuitry 84, processor 86, radio interface 82, etc. The example method includes monitoring (Block S144), such as by monitoring unit 34, processing circuitry 84, processor 86 and/or radio interface 82, for a wake-up signal, WUS, in idle mode, the WUS indicating a presence of a paging physical downlink control channel, PDCCH, in at least one paging occasion, PO, and the WUS being at least one of a physical downlink control channel, PDCCH, signal, a reference signal, RS, a sequence-based signal, a synchronization signal, a secondary synchronization signal, SSS, a primary synchronization signal, PSS, a channel state information reference signal, CSI-RS, and a tracking reference signal, TRS. The method includes when the WUS is detected, monitoring (Block S146), such as by monitoring unit 34, processing circuitry 84, processor 86 and/or radio interface 82, the at least one PO for the indicated paging PDCCH.

In some embodiments, the WUS is a downlink control information, DCI, message on the PDCCH. In some embodiments, the WUS is a non-cell-defining synchronization signal block, SSB, transmission at a predetermined time and/or frequency location, the predetermined location being outside of a cell-defining SSB grid and the non-cell-defining SSB transmission comprising the PSS and the SSS. In some embodiments, the non-cell-defining SSB transmission comprising a plurality of SSSs and the monitoring for the WUS comprising monitoring for at least one SSS corresponding to a WUS group to which the WD belongs. In some embodiments, the method comprises receiving, such as by monitoring unit 34, processing circuitry 84, processor 86 and/or radio interface 82, a reference signal, RS, before monitoring for the WUS, the monitoring for the WUS being a result of receipt of the RS.

In some embodiments, the WUS comprises at least one of: a 0-bit payload; a non-zero size payload; a predetermined downlink control information, DCI, format; a DCI format 2-6; an encoding by a predetermined radio network temporary identifier, RNTI; and WUS group information. In some embodiments, the idle mode is at least one of a radio resource control, RRC, idle state and a RRC inactive state. In some embodiments, the WUS further comprises a paging group indication associating the WUS to at least one paging group. In some embodiments, the WUS further comprises a group indication, the group indication invoking PDCCH monitoring for multiple groups of WDs. In some embodiments, at least one group of the multiple groups of WDs not being paged. In some embodiments, the WUS comprises a sequence, the sequence indicating to the WD to monitor the at least one PO for the indicated paging PDCCH regardless of the group that the WD belongs to.

In some embodiments, the method further includes receiving, such as by monitoring unit 34, processing circuitry 84, processor 86 and/or radio interface 82, a configuration of the WUS, the configuration indicating at least one of a code, a sequence, an offset, a radio network temporary identifier, RNTI, a search space, a downlink control information, DCI, size, a time associated with a validity timer and at least one time and/or frequency resource in which the WUS is to be transmitted. In some embodiments, receiving the configuration of the WUS in at least one of: a system information, SI; a dedicated radio resource control, RRC, when the WD was in a connected mode; and a RRC release message. In some embodiments, the WUS is activated by at least one of: an indicator in at least one of a system information, SI, and a Layer 1, L1, signaling; a paging downlink control information, DCI; and at least one of a presence and an absence of configuration information in the SI.

In some embodiments, the WUS is only valid for a specific amount of time, the specific amount of time being based at least in part on a validity timer. In some embodiments, receiving, such as by monitoring unit 34, processing circuitry 84, processor 86 and/or radio interface 82, the WUS extends the validity timer and/or receiving the paging PDCCH stops the validity timer. In some embodiments, the WUS comprises at least one of: a bandwidth equal to or lower than a synchronization signal block, SSB, bandwidth; a quadrature phase shift keying, QPSK, transmission; and a reduced time duration as compared to a time duration associated with a full-power reception operation.

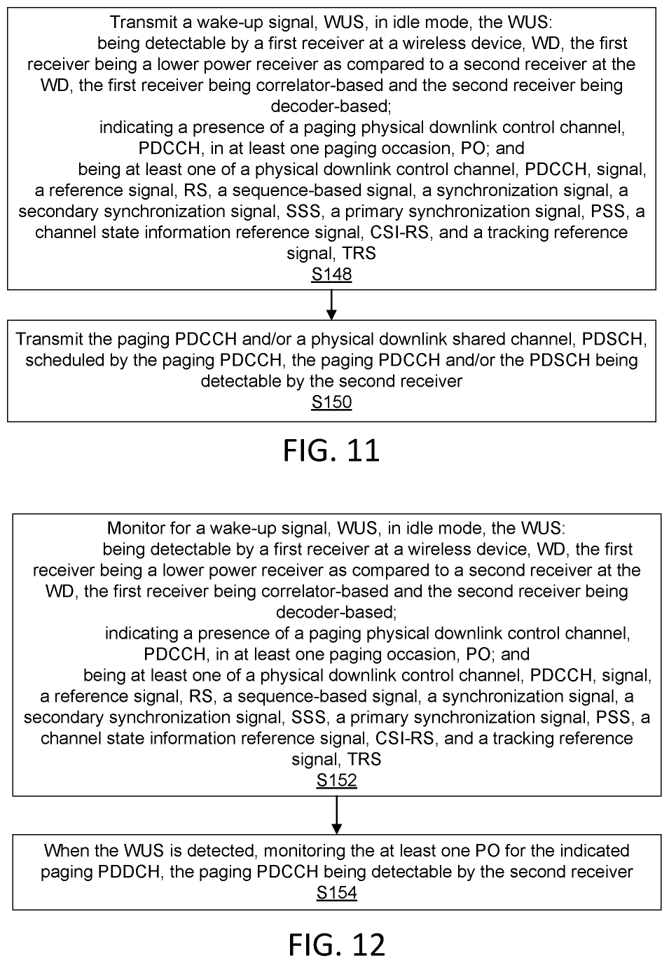

FIG. 11 is a flowchart of an exemplary process in a network node 16 for wake-up signal aspects according to some embodiments of the present disclosure. One or more Blocks and/or functions and/or methods performed by the network node 16 may be performed by one or more elements of network node 16 such as by WUS unit 32 in processing circuitry 68, processor 70, communication interface 60, radio interface 62, etc. according to the example method. The example method includes transmitting (Block S148), such as by WUS unit 32, processing circuitry 68, processor 70, communication interface 60 and/or radio interface 62, a wake-up signal, WUS, in idle mode. The WUS is: detectable by a first receiver at a wireless device, WD, the first receiver being a lower power receiver as compared to a second receiver at the WD, the first receiver being correlator-based and the second receiver being decoder-based; indicates a presence of a paging physical downlink control channel, PDCCH, in at least one paging occasion, PO; and at least one of a physical downlink control channel, PDCCH, signal, a reference signal, RS, a sequence-based signal, a synchronization signal, a secondary synchronization signal, SSS, a primary synchronization signal, PSS, a channel state information reference signal, CSI-RS, and a tracking reference signal, TRS. The method includes transmitting (Block S150), such as by WUS unit 32, processing circuitry 68, processor 70, communication interface 60 and/or radio interface 62, the paging PDCCH and/or a physical downlink shared channel, PDSCH, scheduled by the paging PDCCH, the paging PDCCH and/or the PDSCH being detectable by the second receiver.

In some embodiments, the method further includes transmitting, such as by WUS unit 32, processing circuitry 68, processor 70, communication interface 60 and/or radio interface 62, a configuration associated with a discontinuous reception, DRX, set-up, the configuration being based on a capability of the first receiver and the second receiver. In some embodiments, the configuration at least one of: comprises at least one of a DRX idle period and a WUS-to-PO offset; and is based at least in part on capability information for the first receiver and the second receiver from the WD.

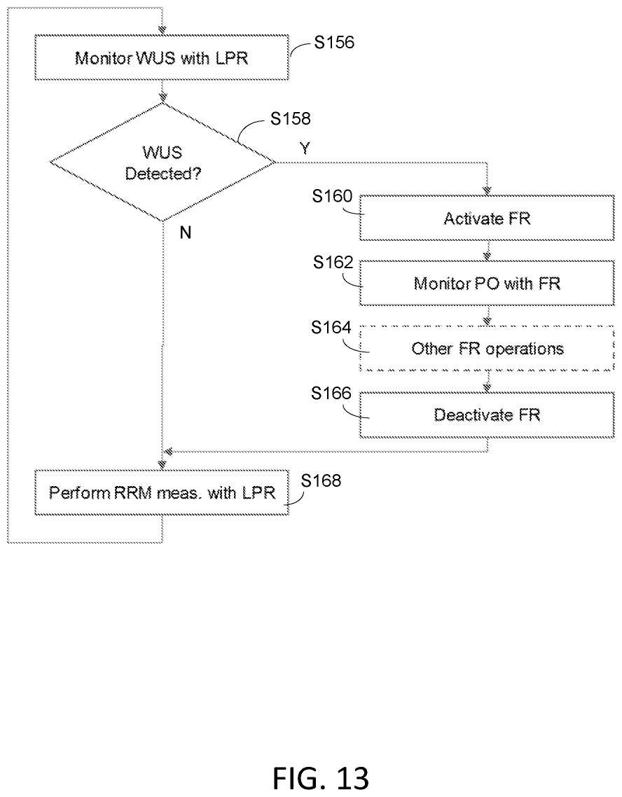

FIG. 12 is a flowchart of an exemplary process in a wireless device 22 for wake-up signal aspects according to some embodiments of the present disclosure. One or more Blocks and/or functions and/or methods performed by WD 22 may be performed by one or more elements of WD 22 such as by monitoring unit 34 in processing circuitry 84, processor 86, radio interface 82, etc. The example method includes monitoring (Block S152), such as by monitoring unit 34, processing circuitry 84, processor 86 and/or radio interface 82, for a wake-up signal, WUS, in idle mode. The WUS is: detectable by a first receiver at a wireless device, WD, the first receiver being a lower power receiver as compared to a second receiver at the WD, the first receiver being correlator-based and the second receiver being decoder-based; indicates a presence of a paging physical downlink control channel, PDCCH, in at least one paging occasion, PO; and at least one of a physical downlink control channel, PDCCH, signal, a reference signal, RS, a sequence-based signal, a synchronization signal, a secondary synchronization signal, SSS, a primary synchronization signal, PSS, a channel state information reference signal, CSI-RS, and a tracking reference signal, TRS. The method includes when the WUS is detected, monitoring (Block S154), such as by monitoring unit 34, processing circuitry 84, processor 86 and/or radio interface 82, the at least one PO for the indicated paging PDCCH, the paging PDCCH being detectable by the second receiver.

In some embodiments, monitoring for the WUS is via a first receiver at the WD, the first receiver being a lower power receiver as compared to a second receiver at the WD. In some embodiments, when the WUS is not detected by the first receiver, continuing, such as by monitoring unit 34, processing circuitry 84, processor 86 and/or radio interface 82, to use the first receiver for monitoring for the WUS; and when the WUS is detected by the first receiver, activating, such as by monitoring unit 34, processing circuitry 84, processor 86 and/or radio interface 82, the second receiver to at least one of monitor the at least one PO for the indicated paging PDCCH and receive a physical downlink shared channel, PDSCH, scheduled by the paging PDCCH.

In some embodiments, at least one of: the first receiver is correlator-based and the second receiver is decoder-based; and when the WUS is being monitored by the first receiver, the first receiver is further used to detect at least one of a primary synchronization signal, PSS, and a secondary synchronization signal, SSS. In some embodiments, the method further includes receiving, such as by monitoring unit 34, processing circuitry 84, processor 86 and/or radio interface 82, a configuration associated with a discontinuous reception, DRX, set-up, the configuration being based on a capability of the first receiver and the second receiver. In some embodiments, the configuration at least one of: comprises at least one of a DRX idle period and a WUS-to-PO offset; and is based at least in part on capability information for the first receiver and the second receiver from the WD.

Having described the general process flow of arrangements of the disclosure and having provided examples of hardware and software arrangements for implementing the processes and functions of the disclosure, the sections below provide details and examples of arrangements for aspects of wake-up signal (WUS) transmission, which may be implemented by the network node 16, wireless device 22 and/or host computer 24.

Part One—LPR-Oriented WUS and DRX in Idle

Introduction

One embodiment of the present disclosure provides an idle mode DRX solution which may be considered to target use cases without paging coverage extension (e.g., without repetitions of paging) and/or which may enable a low power (LP)-receiver WD 22 implementation. For example, if no paging is detected, the full WD receiver (e.g., radio interface 82) remains in deep sleep (estimated on the order of ˜8 mW) and both paging WUS monitoring and RRM measurements on SSB are performed by the WD 22 using the LPR 83 (e.g., in some embodiments, estimated well below 1 mW). A WUS is transmitted by the network node 16 to indicate an imminent paging PDCCH and, when a WD 22 detects the paging PDCCH using its LPR 83, the WD 22 activates the full receiver (e.g., radio interface 82) for monitoring the paging PO and a possible associated PDSCH.

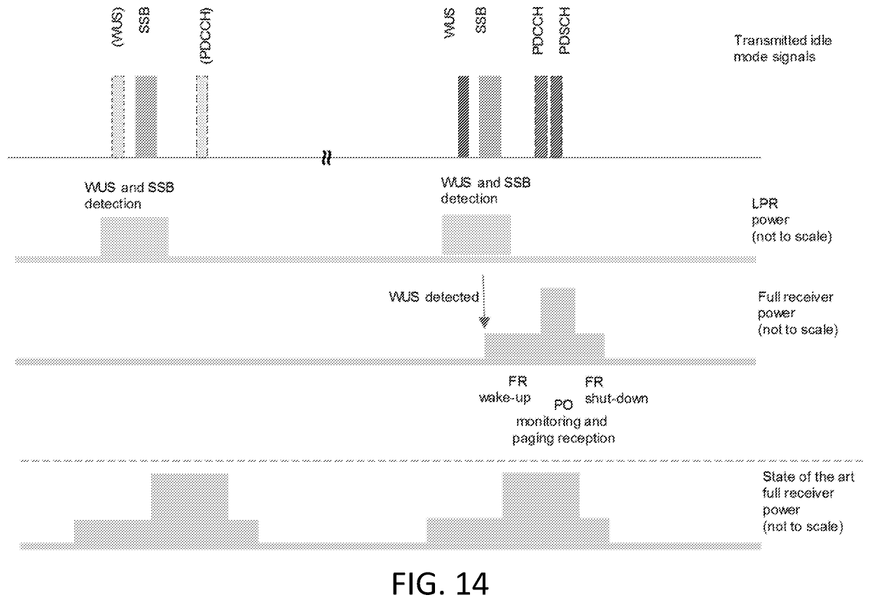

FIG. 13 illustrates an example flow diagram of a unified idle mode solution, related to paging monitoring and other receiver activities (excluding mobile-originated connection activities). In step S156, the WD 22 monitors for WUS using the LPR 83. In step S158, the WD 22 determines whether a WUS is detected by the LPR 83. If yes (the WD detects WUS), in step S160, the WD 22 activates the full receiver (FR) (e.g., radio interface 82). In step S162, the WD 22 monitors the paging occasion (PO) with the FR (e.g., radio interface 82). Optionally, in step S164, the WD 22 may perform one or more other FR operations (e.g., using radio interface 82), which may include PDSCH reception, Random Access (RA) and connected mode operation, and RRM measurements, e.g., SSB or other RS (e.g., CSI-RS, TRS, etc.). In step S166, the WD 22 may deactivate the FR (e.g., radio interface 82). The process may proceed to step S168, where the WD 22 may perform RRM measurements using the LPR 83.

FIG. 13 illustrates a corresponding example timeline of signal transmission and WD 22 activity. (Note that the power levels are not to scale, neither for intra-radio type nor for inter-radio type.) It should be noted that the network node 16 transmits the WUS, SSB, PDCCH and physical downlink shared channel (PDSCH) idle mode signals shown in FIG. 13. As can be seen in FIG. 13, the LPR 83 and FP receiver (e.g., radio interface 82) embodiment reduces the energy consumed by the FP receiver for the transmitted idle mode signals, as compared to the existing use of the FP receiver for the transmitted idle mode signals.

Below we describe in more detail one or more aspects of the unified solution according to some embodiments of the present disclosure. The aspects may also be used individually, as part of other solutions concepts, or combining multiple aspects but not the entire presented solution.

WUS Signal Design

In some embodiments, the WUS in this DRX solution is designed to be detectable by a LP-receiver (e.g., LPR 83) in a WD 22. In some embodiments, the WUS signal may be represented as a predetermined time-domain sequences (although possibly defined in terms of resource element (RE) contents in the Frequency domain), or one of a limited number of such sequences to be detectable by, e.g., a sliding correlator in the time domain with a small number of sequence hypotheses. The sequence may be e.g., a primary synchronization signal (PSS)—like sequence, secondary synchronization signal (SSS)—like sequence, physical random access channel (PRACH-like), or channel state information-reference signal (CSI-RS)-like sequence, or another sequence with controlled auto- and/or cross-correlation properties.

In particular, to facilitate LPR reception, the WUS may be designed to be received using a limited-bandwidth (BW) RF front end. In one embodiment, the WUS BW may be equal to or lower than the SSB BW. In another aspect, the WUS may constitute a quadrature phase-shift keying (QPSK) transmission to allow radio operation with possibly lower linearity requirements. In some embodiments, the WUS signal may also be designed with reduced time duration to reduce the number of samples per correlation operation.

In some embodiments, the WUS can also be a PDCCH based signal with 0-bit or e.g., non-zero fixed/known payload scrambled with a predetermined downlink control channel (DCI) format and radio network temporary identifier (RNTI), transmitted in a search space (SS) with a single or a small number of format and T/F allocation options. The RNTI can be e.g., a cell-RNIT (C-RNTIz), a function of C-NRTI (f(C-RNTI)), a new RNTI for idle mode WUS, a function of the new RNTI e.g., for different group of WDs 22 and so on. Since, the payload may be zero in some embodiments, the WD 22 may not necessarily use decoder-based PDCCH detection, but may use LPR-based ones, e.g., correlator-based ones. In general, it should be understood that a PDCCH with predetermined contents may also be viewed as a sequence-based WUS and it would allow performing other functions defined for RS-based WUS options.

In some embodiments, the WUS may include paging group indication, e.g., by associating a predetermined or configured sequence, including DCI payload or RNTI, with a group identity in a group paging setup.

In one embodiment, different WUS signals, e.g., belonging to different paging groups, may be transmitted in different frequency allocations to allow multiple groups to be woken up simultaneously, if applicable. In one embodiment, one WUS sequence indicates that any WD 22 monitoring the WUS location should perform PO monitoring, regardless of their group assignment.

DRX Setup

In some embodiments, the network node 16 may configure the WD 22 with a DRX setup that provides a desired trade-off between power saving and WD 22 power saving using the LP-receiver (e.g., LPR 83).

In one embodiment, if the WD 22 LPR radio power is determined to be significantly below full radio deep sleep power, the network node 16 may choose to apply a relatively shorter idle DRX period (DRX densification) to achieve low paging latency for some use cases without adverse WD 22 EE impact. The network node 16 may apply PO periods as low as some 100 s of a ms.

In some embodiments, the network node 16 may configure a WUS-to-PO offset to allow the full receiver (e.g., radio interface 82) time to wake-up after WUS detection. As an example, an offset in the range of 10-30 ms may be configured in the DRX setup, similar to the WD 22 deep sleep transition time according to the 3GPP Technical Specification (TS) 38.814 model. The offset may be based on e.g., subcarrier spacing (SCS), WD type, WD capabilities, and/or WD assistance/preference signaling. The WD 22 may provide the capability and assistance information via e.g., radio resource control (RRC) signaling.

In some embodiments, the network node 16 may further configure a WUS-to-SSB offset to be short to minimize the receiver on-time. However, in some embodiments, the network node 16 may not optimize the offset but allow the LPR 83 to perform SSB at any time since the related overhead is low or negligible.

In some embodiments, the offset value may be provided in system information (SI) (e.g., in remaining minimum system information (RMSI), other system information (OSI), etc.), or via dedicated RRC signaling before releasing to idle. In a related embodiment, the network node 16 may transmit a WUS to a given WD 22 or WD group with a customized offset before their imminent WUS, although many WDs 22 may share the same PO.

Unified Idle Mode WD Solution Using LPR

In some embodiments, the WD 22 with a LP-receiver implementation for idle mode may operate mostly without activating the full radio (e.g., radio interface 82), unless a WUS is received and PO monitoring is necessary.

In one aspect, the WD 22 uses a LPR 83 with capability of coherent I/Q sampling and buffering, but with a simplified RF front end, sampling, and baseband processing. The WD 22 may use e.g., a lower-linearity, lower-sensitivity RF conversion and a lower-resolution analog-to-digital converter (ADC) processing before baseband. The baseband may include primarily time-domain (T-domain) sliding correlator circuitry for correlating with one or more sequence hypotheses.

The frequency synchronization (F-sync) may be achieved by correlating the receiver sample stream with respect to multiple reference sample streams for each sequence to be detected, each T-domain sample stream representing a different F-offset version of the sequence to be detected, where the number of different F-offset hypotheses is based on the estimated worst-case F-drift since last signal reception, depending on the time elapsed and F-stability of the LPR 83 in a free-running mode. In one embodiment, for the purpose of limiting F-drift over time, the WD 22 LPR 83 may additionally detect the PSS or SSS in the recurring SSB transmitted by the camping cell's network node 16. A WD 22 may detect frequent SSBs (e.g., 20-80 ms period), perform frequency correction based on the reception, and omit additional F-hypotheses for WUS detection.

In some embodiments, e.g., when the LPR 83 power consumption is significantly lower (e.g., 15% or less) than the full receiver (e.g., radio interface 82) deep sleep power consumption, i.e., the additional LPR 83 power consumption is negligible, the LPR 83 may be operating and performing WUS monitoring and/or SSB measurements continuously. In an example WD 22 implementation, the LPR 83 (also referred to as wake-up radio, WUR in this context) may apply continuous AGC updates with a filtering or peak detection period equal to, not shorter than, the SSB transmission period in the cell. In some embodiments, the LPR 83 may operate without explicit T/F synchronization. T-sync may be achieved by virtue of the sliding correlation in T-domain. In other embodiments, the LPR 83 may be gated, operating only in the vicinity of the anticipated WUS monitoring and RRM measurement (SSB position) times.

In some embodiments, the WD 22 may furthermore perform camping cell SSB measurement using the LPR 83 by correlating the relevant received SSB contents (e.g., SSS) with a reference sequence for the purposes of e.g., reference signal received power (RSRP) estimation. The WD 22 may calibrate the LPR-based and full-receiver SSB quality estimation results for the purposes of comparing to candidate cell qualities. In an alternative embodiment, the WD 22 may use the WUS detection/correlation result in the LPR 83 as a link quality metric.

In some WD 22 designs, the LPR 83 may provide sufficient reception quality (e.g., in terms of signal-to-noise ratio (SNR) or dynamic range) only in part of the cell coverage area but not in others, e.g., at an extreme cell edge or near-gNB areas. The WD 22 may then determine the relevant operating point parameters using the full receiver (e.g., radio interface 82) and determine whether the operating point is suitable for LPR 83 operation. If so, the WD 22 invokes LPR mode to use LPR 83, otherwise idle mode operation will use the full receiver (e.g., radio interface 82). In intermediate scenarios, the WD 22 may additionally operate the full receiver (e.g., radio interface 82) in a lower-power/lower-fidelity mode, depending on the determined operating point.

In some embodiments, if the WUS receiver (LPR/WUR 83) detects a WUS, it activates the main/primary/full receiver (e.g., radio interface 82) for PO monitoring. Using the configured WUS-PO offset information, the full/primary receiver in the radio interface 82 is activated in time for PO reception, given its required sleep-to-active transition time duration. In some embodiments, AGC and/or F-sync information from the LPR 83 may be used to tune the full/primary receiver in the radio interface 82 and obviate the need for additional SSB or other RS reception.

Part Two—PDCCH- or RS-Based WUS for Idle

Introduction

In one embodiment of an idle mode WUS approach, the network node 16 transmits a short-duration WUS to indicate the presence of a paging PDCCH in the next PO. This may obviate the need for the WD 22 in non-cross-slot paging configurations (i.e., when the WD 22 is unable to ascertain, e.g., from DCI signaling or by other means, that a guaranteed minimum delay will be imposed between the paging PDCCH and scheduled PDSCH that is sufficient for PDCCH decoding) to perform longer-duration signal monitoring to capture first the PDCCH samples and subsequently PDSCH samples during PDCCH decoding. The WUS may contain grouping information to trigger paging monitoring for only a subset of WDs 22. The WUS, e.g., if it is a RS-based signal, may be used for RRM measurements and additional RS may be provided in the proximity of the WUS for AGC and/or T/F sync.

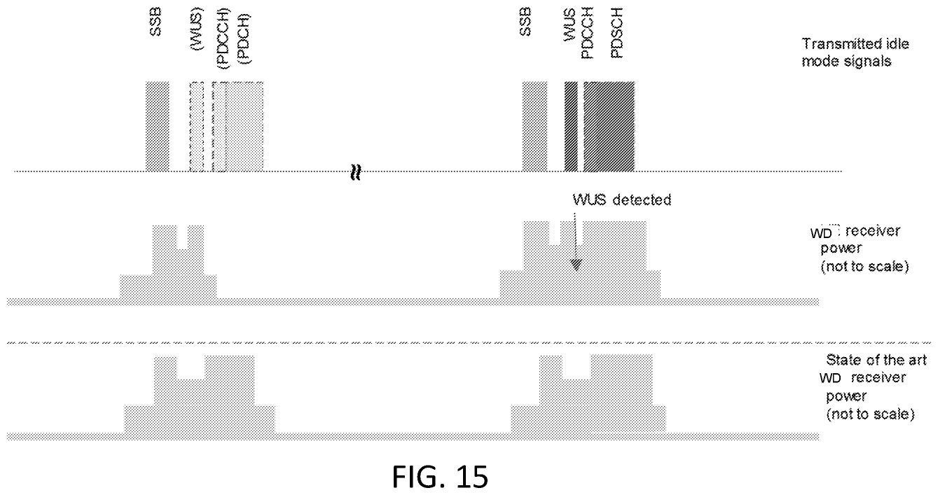

FIG. 14 illustrates an example timeline for signal transmissions and WD 22 processing according to some embodiments of the present disclosure (power levels are not drawn to scale). It should be noted that the network node 16 transmits the WUS, SSB, PDCCH and physical downlink shared channel (PDSCH) idle mode signals shown in FIG. 14.

WUS Design and Grouping Information

In one embodiment, the WUS may be a PDCCH, e.g., similar to the Rel-16 connected mode power-saving signal design using DCI format 2-6, or another or new DCI format. The SS for the idle-PDCCH-WUS monitoring may be provided in SI (e.g., RMSI, OSI).

In some embodiments, the grouping information embedded in WUS may reflect the grouping information conveyed in the group paging (PDCCH grouping) solution that is embedded e.g., in the DCI or via group-specific paging-RNTI (P-RNTI). It may also have a different granularity, e.g., coarser where group indication in WUS may invoke PDCCH monitoring for multiple groups, including those not paged. Furthermore, the DCI payload may have size from 0-WUSIdleDCIsize (bits), allowing the network node 16 to flexibly configure the payload. For example, if the DCI with 0-bit payload is detected by the WD 22 (by passing the check of the cyclic redundancy check (CRC) scrambled with RNTI), then the WD 22 monitors one or more POs as configured by the network node 16 or perform other FR functions.

Alternatively, or additionally, in some embodiments, WUS functionality is provided by (e.g., network node 16) transmitting a RS (also called RS-WUS), e.g., CSI-RS or TRS or any other sequence-based signal. A signal (e.g., RS) having a predetermined configuration (e.g., CSI-RS resource set configuration (code, T/F location, etc.)) may be detected by a WD 22 as an indication of a pending paging transmission in a PO. The RS-WUS may include one or more symbols transmitted in the same or different slots.

In a related embodiment, the network node 16 may configure the WD 22 with e.g., a TRS/CSI-RS right before each or a number of POs. Furthermore, the network node 16 may configure the WD 22 such that if TRS/CSI-RS is not present in the pre-configured occasions, the WD 22 may not need to monitor the PO, or does not monitor PO. In some embodiments, the network node 16 may configure the WD 22 such that if TRS/CSI-RS is present in the pre-configured occasions, the WD 22 may monitor the PO. In another example, if the WD 22 is further configured with multiple slots RSs, it can use one of the slots as WUS, and the rest to perform RRM measurements.

In cases where LPR 83 is used for WUS detection, the WD 22 may further apply calibration coefficients to relate the RRM measurements to the ones of the primary/full radio (FR) (e.g., radio interface 82). The calibration coefficients can be a function of AGC of LPR 83, e.g., AGC of FR=f(AGC of LPR), or a function of AFC of LPR, e.g., AFC of FR=f(AFC of LPR). The function may be further trained, learned, estimated or determined based on the previous measurement instances, or alternatively based on specific models. This in turn can lower the power consumption of the primary/full radio.

Alternatively, or additionally, in some embodiments, the WUS may be implemented as a non-cell-defining SSB-like transmission in a predetermined time and/or frequency (T/F) location of the cell-defining SSB grid, using a structure similar to first two symbols of the conventional SSB. For example, a single PSS code may be used and one or more possible secondary synchronization signal (SSS) codes. The multiple SSS code options may be used for inserting grouping information; a WD 22 may monitor a SSS code corresponding to its group allocation.

WUS Configuration Information Provision

In one class of embodiments, WUS configuration may be provided in SI (e.g., RMSI, OSI, system information block n (SIBn)). Configuration information may include code, offset, SS; T/F location (e.g., time/frequency position and/or resource), etc.

WUS activation indication may be explicit, via an indicator bit in the SI, or implicit through presence or absence of configuration information in SI. It can also be based on L1 indications e.g., the current paging DCI can activate/deactivate idle mode WUS.

In another class of embodiments, WUS may be provided only to WDs 22 that last connected in the camping cell. Configuration information may be provided via dedicated RRC while the WD 22 is in connected mode.

In another example, the idle mode WUS configuration is part of the RRC release message.

In another example, the idle mode WUS is only valid for a specific amount of time, determined by a validity timer. The validity timer can be in units of slots, POs, milliseconds, or any other time unit. The network node 16 may further configure the WD 22 with specific indications to extend or stop the validity timer, e.g., reception of idle mode WUS may extend the validity timer, or an indication e.g., in a paging DCI can stop the timer.

In some embodiments, the configuration information provision aspects described here may also apply to part one of the present disclosure.

RRM Measurements Using WUS

In one embodiment, the WUS may be used for RRM measurements during the current DRX cycle. The WD 22 may store the WUS samples. If a WUS is successfully detected, its contents will be known and the WUS samples may be used for signal quality, e.g., RSRP, measurements. If WUS is detected using a correlator receiver, the correlator output may be used as a channel quality metric. The WD 22 may determine calibration of the WUS-based quality metric and the conventional SSB-based (e.g., SSS-based) metric by measuring both signals during some DRX cycles and determining the scaling factor, e.g., a power ratio.

Additional RS for AGC and T/F Sync

In one embodiment, the network node 16 may configure additional RS to provide AGC and/or synchronization opportunities in the vicinity or shortly before the WUS transmission. The additional RS (a-RS) may be (non-cell-defining) SSB, TRS, CSI-RS, etc., or similar/related designs. The a-RS may be transmitted by the network node 16 only when the WUS is transmitted. The a-RS for synchronization may be a single predefined sequence or a small set of possible sequences to allow an efficient time-domain correlation receiver. In one embodiment, if the WD 22 does not detect an a-RS for T/F synchronization, the WD 22 does not attempt WUS reception. In one embodiment, this is further an indicator that paging PDCCH will not be transmitted and the WD 22 will not monitor the PO.

Some embodiments may include one or more of the following:

Embodiment A1. A network node configured to communicate with a wireless device (WD), the network node configured to, and/or comprising a radio interface and/or comprising processing circuitry configured to:

transmit a wake-up signal (WUS), the WUS indicating a presence of a paging physical downlink control channel (PDCCH) in at least one paging occasion; and

transmit the PDCCH and/or a physical downlink shared channel (PDSCH) scheduled by the PDCCH.

Embodiment A2. The network node of Embodiment A1, wherein the network node and/or the radio interface and/or the processing circuitry is further configured to cause the network node to:

transmit the WUS by being configured to transmit the WUS to be detectable by a low power receiver (LPR); and

transmit the PDCCH and/or the PDSCH by being configured to transmit the PDCCH and/or the PDSCH to be detectable by a primary WD receiver, the LPR being different from the primary receiver.

Embodiment A3. The network node of Embodiment A1, wherein the LPR is a lower power receiver as compared to the primary receiver.

Embodiment A4. The network node of Embodiment A1, wherein the network and/or radio interface and/or processing circuitry is configured to transmit the WUS by being configured to:

transmit the WUS to the WD in idle mode discontinuous reception (DRX).

Embodiment A5. The network node of Embodiment A1, wherein the WUS:

is at least one of a physical downlink control channel (PDCCH), a sequence-based signal, a reference signal, a synchronization signal, a channel state information reference signal (CSI-RS) and a tracking reference signal; and/or includes a payload and/or group information.

Embodiment A6. The network node of Embodiment A1, wherein the network node and/or radio interface and/or processing circuitry is further configured to:

transmit a configuration of the WUS, the configuration indicating at least one of a code, a sequence, an offset, a search space and at least one time/frequency resource in which the WUS is to be transmitted.

Embodiment B1. A method implemented in a network node, the method comprising:

transmit a wake-up signal (WUS), the WUS indicating a presence of a paging physical downlink control channel (PDCCH) in at least one paging occasion; and

transmit the PDCCH and/or a physical downlink shared channel (PDSCH) scheduled by the PDCCH.

Embodiment B2. The method of Embodiment B1, wherein:

transmitting the WUS includes transmitting the WUS to be detectable by a low power receiver (LPR); and

transmitting the PDCCH and/or the PDSCH includes transmitting the PDCCH and/or the PDSCH to be detectable by a primary WD receiver, the LPR being different from the primary receiver.

Embodiment B3. The method of Embodiment B1, wherein the LPR is a lower power receiver as compared to the primary receiver.

Embodiment B4. The method of Embodiment B1, wherein transmitting further comprises:

transmitting the WUS to the WD in idle mode discontinuous reception (DRX).

Embodiment B5. The method of Embodiment B1, wherein the WUS:

is at least one of a physical downlink control channel (PDCCH), a sequence-based signal, a reference signal, a synchronization signal, a channel state information reference signal (CSI-RS) and a tracking reference signal; and/or includes a payload and/or group information.

Embodiment B6. The method of Embodiment B1, further comprising:

transmitting a configuration of the WUS, the configuration indicating at least one of a code, a sequence, an offset, a search space and at least one time/frequency resource in which the WUS is to be transmitted.

Embodiment C1. A wireless device (WD) configured to communicate with a network node, the WD configured to, and/or comprising a radio interface and/or processing circuitry configured to:

monitor for a wake-up signal (WUS), the WUS indicating a presence of a paging physical downlink control channel (PDCCH) in at least one paging occasion.

Embodiment C2. The wireless device of Embodiment C1, wherein the WD and/or radio interface and/or processing circuitry is configured to monitor by being configured to:

monitor, via a lower power receiver (LPR), for the WUS:

when the WUS is not detected by the LPR, continue to use the LPR for WUS monitoring; and

when the WUS is detected by the LPR, activate a primary receiver to monitor the at least one paging occasion for the indicated paging PDCCH and/or receive a physical downlink shared channel (PDSCH) scheduled by the PDCCH, the LPR being different from the primary receiver.

Embodiment C3. The wireless device of Embodiment C2, wherein the LPR is a lower power receiver as compared to the primary receiver.

Embodiment C4. The wireless device of Embodiment C1, wherein the WD and/or radio interface and/or processing circuitry is configured to monitor by being configured to:

monitor for the WUS in idle mode discontinuous reception (DRX).

Embodiment C5. The wireless device of Embodiment C1, wherein the WUS:

is at least one of a physical downlink control channel (PDCCH), a sequence-based signal, a reference signal, a synchronization signal, a channel state information reference signal (CSI-RS) and a tracking reference signal; and/or

includes a payload and/or group information.

Embodiment C6. The wireless device of Embodiment C1, wherein the WD and/or radio interface and/or processing circuitry is further configured to:

receive a configuration of the WUS, the configuration indicating at least one of a code, a sequence, an offset, a search space and at least one time/frequency resource in which the WUS is to be transmitted.

Embodiment D1. A method implemented in a wireless device (WD), the method comprising:

monitoring for a wake-up signal (WUS), the WUS indicating a presence of a paging physical downlink control channel (PDCCH) in at least one paging occasion.

Embodiment D2. The method of Embodiment D1, wherein monitoring includes monitoring, via a lower power receiver (LPR), for the WUS:
when the WUS is not detected by the LPR, continuing to use the LPR for WUS monitoring; and
when the WUS is detected by the LPR, activating a primary receiver to monitor the at least one paging occasion for the indicated paging PDCCH and/or receiving a physical downlink shared channel (PDSCH) scheduled by the PDCCH, the LPR being different from the primary receiver.

Embodiment D3. The method of Embodiment D2, wherein the LPR is a lower power receiver as compared to the primary receiver.

Embodiment D4. The method of Embodiment D1, wherein monitoring further comprises the WD monitoring for the WUS in idle mode discontinuous reception (DRX).

Embodiment D5. The method of Embodiment D1, wherein the WUS:

is at least one of a physical downlink control channel (PDCCH), a sequence-based signal, a reference signal, a synchronization signal, a channel state information reference signal (CSI-RS) and a tracking reference signal; and/or

includes a payload and/or group information.

Embodiment D6. The method of Embodiment D1, further comprising:

receiving a configuration of the WUS, the configuration indicating at least one of a code, a sequence, an offset, a search space and at least one time/frequency resource in which the WUS is to be transmitted.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method implemented in a wireless device, WD, the method comprising:
monitoring for a wake-up signal, WUS, in idle mode, the WUS indicating a presence of a paging physical downlink control channel, PDCCH, in at least one paging occasion, PO, and the WUS being at least one of a physical downlink control channel, PDCCH, signal, a reference signal, RS, a sequence-based signal, a synchronization signal, a secondary synchronization signal, SSS, a primary synchronization signal, PSS, a channel state information reference signal, CSI-RS, and a tracking reference signal, TRS; and
when the WUS is detected, monitoring the at least one PO for the indicated paging PDCCH.

2.-5. (canceled)

6. The method of claim 1, wherein the WUS comprises at least one of:
a 0-bit payload;
a non-zero size payload;
a predetermined downlink control information, DCI, format;
a DCI format 2-6;
an encoding by a predetermined radio network temporary identifier, RNTI; and
WUS group information.

7. (canceled)

8. The method of claim 1, wherein the WUS further comprises a paging group indication associating the WUS to at least one paging group.

9. The method of claim 1, wherein the WUS further comprises a group indication, the group indication invoking PDCCH monitoring for multiple groups of WDs.

10. The method of claim 9, wherein at least one group of the multiple groups of WDs not being paged.

11. (canceled)

12. The method of claim 1, further comprising:
receiving a configuration of the WUS, the configuration indicating at least one of a code, a sequence, an offset, a radio network temporary identifier, RNTI, a search space, a downlink control information, DCI, size, a time associated with a validity timer and one or more of at least one time and frequency resource in which the WUS is to be transmitted.

13. The method of claim 12, wherein receiving the configuration of the WUS in at least one of:
a system information, SI;
a dedicated radio resource control, RRC, when the WD (22) was in a connected mode; and
a RRC release message.

14.-17. (canceled)

18. A method implemented in a network node configured to communicate with a wireless device, WD, the method comprising:
transmitting a wake-up signal, WUS, in idle mode the WUS indicating a presence of a paging physical downlink control channel, PDCCH, in at least one paging occasion, PO, and the WUS being at least one of a physical downlink control channel, PDCCH, signal, a reference signal, RS, a sequence-based signal, a synchronization signal, a secondary synchronization signal, SSS, a primary synchronization signal, PSS, a channel state information reference signal, CSI-RS, and a tracking reference signal, TRS; and
transmitting one or more of the paging PDCCH and a physical downlink shared channel, PDSCH, scheduled by the paging PDCCH.

19.-22. (canceled)

23. The method of claim 18, wherein the WUS comprises at least one of:
a 0-bit payload;
a non-zero size payload;
a predetermined downlink control information, DCI, format;
a DCI format 2-6;
an encoding by a predetermined radio network temporary identifier, RNTI; and
WUS group information.

24. (canceled)

25. (canceled)

26. The method of claim 18, wherein the WUS further comprises a group indication, the group indication invoking PDCCH monitoring for multiple groups of WDs.

27. The method of claim 26, wherein at least one group of the multiple groups of WDs not being paged.

28.-34. (canceled)

35. A wireless device, WD, configured to communicate with a network node, the WD comprising processing circuitry, the processing circuitry configured to cause the WD to:
monitor for a wake-up signal, WUS, in idle mode, the WUS indicating a presence of a paging physical downlink control channel, PDCCH, in at least one paging occasion, PO, and the WUS being at least one of a physical downlink control channel, PDCCH, signal, a reference signal, RS, a sequence-based signal, a synchronization signal, a secondary synchronization signal, SSS, a primary synchronization signal, PSS, a channel state information reference signal, CSI-RS, and a tracking reference signal, TRS; and
when the WUS is detected, monitor the at least one PO for the indicated paging PDCCH.

36.-39. (canceled)

40. The WD of claim 35, wherein the WUS comprises at least one of:
a 0-bit payload;
a non-zero size payload;
a predetermined downlink control information, DCI, format;
a DCI format 2-6;
an encoding by a predetermined radio network temporary identifier, RNTI; and
WUS group information.

41. (canceled)

42. The WD of claim 35, wherein the WUS further comprises a paging group indication associating the WUS to at least one paging group.

43. The WD of claim 35, wherein the WUS further comprises a group indication, the group indication invoking PDCCH monitoring for multiple groups of WDs.

44. The WD of claim 43, wherein at least one group of the multiple groups of WDs not being paged.

45. (canceled)

46. The WD of claim 35, wherein the processing circuitry is configured to cause the WD to:
receive a configuration of the WUS, the configuration indicating at least one of a code, a sequence, an offset, a radio network temporary identifier, RNTI, a search space, a downlink control information, DCI, size, a time associated with a validity timer and one or more of at least one time and frequency resource in which the WUS is to be transmitted.

47. The WD of claim 46, wherein the processing circuitry is configured to cause the WD to receive the configuration of the WUS in at least one of:
a system information, SI;
a dedicated radio resource control, RRC, when the WD was in a connected mode; and
a RRC release message.

48.-51. (canceled)

52. A network node configured to communicate with a wireless device, WD, the network node comprising processing circuitry, the processing circuitry configured to cause the network node to:
transmit a wake-up signal, WUS, in idle mode the WUS indicating a presence of a paging physical downlink control channel, PDCCH, in at least one paging occasion, PO, and the WUS being at least one of a physical downlink control channel, PDCCH, signal, a reference signal, RS, a sequence-based signal, a synchronization signal, a secondary synchronization signal, SSS, a primary synchronization signal, PSS, a channel state information reference signal, CSI-RS, and a tracking reference signal, TRS; and
transmit one or more of the paging PDCCH and a physical downlink shared channel, PDSCH, scheduled by the paging PDCCH.

53.-59. (canceled)

60. The network node of claim 52, wherein the WUS further comprises a group indication, the group indication invoking PDCCH monitoring for multiple groups of WDs.

61.-70. (canceled)
